(19) United States
(12) Patent Application Publication
(10) Pub. No.: US 2003/0123141 A1
(43) Pub. Date: Jul. 3, 2003

(54) L band optical amplifier

(76) Inventor: Aydin Yeniay, Strafford, PA (US)

Correspondence Address: MONTE & MCGRAW, PC, 4092 SKIPPACK PIKE, P.O. BOX 650, SKIPPACK, PA, 19474, US

(21) Appl. No.: 10/299,500

(22) Filed: Nov. 18, 2002

Related U.S. Application Data
(60) Provisional application No. 60/331,680, filed on Nov. 19, 2001.

(51) Int. Cl. H01S 3/00

(52) U.S. Cl. 359/349

(57) ABSTRACT

An optical amplifier is disclosed. The amplifier includes an input and an optical splitter adapted to split the input into at least a first band signal portion and a second band signal portion. The first band signal portion includes a first reflector disposed optically downstream from the input, an amplifying gain medium disposed optically downstream from the first reflector, and a second reflector disposed optically downstream from the amplifying gain medium. A first amplifying power source is optically connected to the amplifying gain medium optically upstream from the amplifying gain medium and a second amplifying power source is optically connected to the amplifying gain medium optically downstream from the amplifying gain medium. The first reflector reflects a first light from the amplifying medium back into the amplifying medium and the second reflector reflects a second light from the amplifying medium back into the amplifying medium.

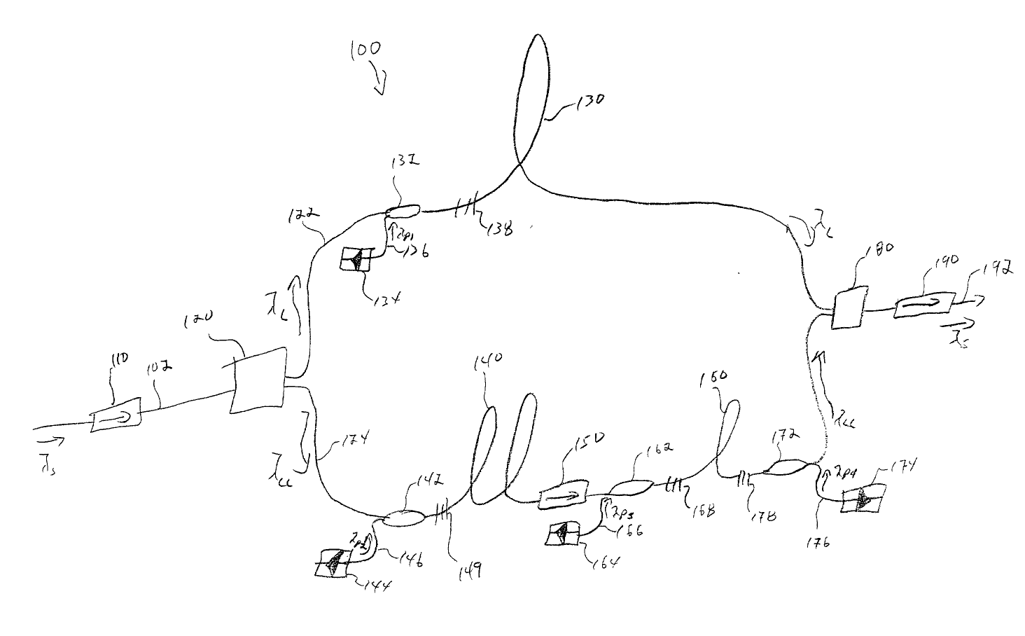

### FIELD OF THE INVENTION

The present application relates to optical amplifiers that amplify optical signals over the long optical wavelength band of approximately 1565-1620 nanometers.

### BACKGROUND OF THE INVENTION

Conventional erbium doped fiber amplifiers (EDFA) have been extensively used in optical telecommunications as means to amplify weak optical signals in the third telecommunication window (near 1550 nm) between telecommunication links. Much work has been done on the design of these amplifiers to provide efficient performance, such as high optical gain and low noise figure. However, with the recent enormous growth of data traffic in telecommunications, owing to the Internet, intranets, and e-commerce, new optical transmission bandwidths are required to provide increased transmission capacity in dense wavelength division multiplexing (DWDM) systems.

There are a few solutions to this demand. One proposed solution is to utilize new materials compositions as a host for the fiber gain medium (instead of silica), such as telluride, which may provide broader amplification bandwidth (up to 80 nm). However, the non-uniform gain shape and poor mechanical properties of telluride glass make these amplifiers difficult to implement in telecommunication systems. Also, Raman amplifiers can be considered as an alternative solution to high bandwidth demand, since these amplifiers are capable of providing flexible amplification wavelength with a broad bandwidth. However, these amplifiers place restrictions on optical system architectures because of their required designs for efficient performance, such as long fiber length (>1 km), high pump power (>100 mW) and co-pumping configurations. On the other hand, relatively long erbium doped fibers (EDFS) may also provide amplification in the long wavelength range (1565-1620 nm) when they are used with high power pump sources. This range is commonly called “L band”, which can be further subdivided in a 1565-1605 nanometers range and a 1605 nanometers and greater range, which is referred to as “ultra-L band”. The conventional range, currently being used for most commercial applications, also known as “C band”, is in the wavelength range between 1520-1165 nm.

With the need to increase transmission capacity to accommodate the rapid growth of optical telecommunications, the industry is looking to L band and possibly ultra-L band as solutions to this need. However, in order to amplify L band and ultra-L band signals, multiple amplifiers are currently required. It would be beneficial to provide a single optical amplifier that amplifies a light signal over a large bandwidth encompassing L band and ultra-L band light.

### BRIEF SUMMARY OF THE INVENTION

Briefly, the present invention provides an optical amplifier comprising an input and an optical splitter optically connected to the input, the optical splitter being adapted to split the input into at least a first band signal portion and a second band signal portion. The first band signal portion includes a first reflector disposed optically downstream from the input, a first amplifying gain medium disposed optically downstream from the first reflector, and a second reflector disposed optically downstream from the first amplifying gain medium. A first amplifying power source is optically connected to the first amplifying gain medium optically upstream from the first amplifying gain medium and a second amplifying power source is optically connected to the first amplifying gain medium optically downstream from the first amplifying gain medium. The first reflector reflects a first light from the first amplifying medium back into the first amplifying medium and the second reflector reflects a second light from the first amplifying medium back into the first amplifying medium. The amplifier further includes an optical combiner optically connected to the at least first and second band signal portions to form an output.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

The Figure is a schematic view of an optical amplifier according to a first embodiment of the present invention.

### DETAILED DESCRIPTION OF THE INVENTION

In the drawings, like numerals indicate like elements throughout. As used herein, when two or more elements are “optically connected”, light may be transmitted between the elements. Further, a second element is “optically downstream” of a first element when a light being transmitted through the first and second elements encounters the first element prior to encountering the second element. Also, “backward” is defined to mean a direction optically from a receiver toward a transmission source and “forward” is defined to mean a direction optically from the transmission source toward the receiver.

An optical amplifier 100 according to a preferred embodiment of the present invention is shown schematically in the Figure. The optical amplifier 100 is preferably a planar waveguide, although those skilled in the art will recognize that the optical amplifier 100 may also be fiber based. The amplifier 100 includes an input 102 where a signal light λ_{S} enters the amplifier 100 from a transmission source (not shown). A first optical isolator 110 is optically connected to the input 102 optically downstream from the transmission source. The first optical isolator 110 prevents optical noise from traveling backwards from the amplifier 100 toward the transmission source. An optical splitter 120 is optically connected to the first optical isolator 110. The optical splitter 120 may be an arrayed waveguide grating (AWG), a wavelength division multiplexer (WDM), or an optical circulator with reflectors, such as optical gratings.

Preferably, the optical splitter 120 splits the input 102 into two lines, a first signal line 122 and a second signal line 124. The first signal line 122 is optically connected to a first amplifying gain medium 130. Preferably, the first amplifying gain medium 130 is a rare earth doped medium, such as a fiber or a planar waveguide. Also preferably, the first amplifying gain medium 130 is approximately fifteen meters long. A first optical multiplexer 132 optically connects an amplifying power source, preferably a first pump laser 134, to the first amplifying gain medium 130 via a pump line 136. Preferably, the first pump laser 134 is a 980 nanometer pump laser and has a power of approximately 90 mW, although those skilled in the art will recognize that the first pump laser 134 may be other than 980 nanometers, such as 1480 nanometers, and have a power of other than 90 mW. A reflector 138 is optically disposed in the first signal line 122 between the first optical multiplexer 132 and the first amplifying gain medium 130. The reflector 138 may be a fiber grating or other reflector designed to reflect predetermined wavelengths. While a single reflector 138 is shown, those skilled in the art will recognize that the reflector 138 may include a plurality of reflectors 138. Preferably, the reflector 138 is tuned to reflect light having a wavelength of between approximately 1535 to 1560 nm.

The second signal line 124 is optically connected to a second amplifying gain medium 140. Preferably, the second amplifying gain medium 140 is a rare earth doped medium, such as a fiber or a planar waveguide. Also preferably, the second amplifying gain medium 140 is approximately sixty meters long. A second optical multiplexer 142 optically connects an amplifying power source, preferably a second pump laser 144, to the second amplifying gain medium 140 via a pump line 146. Preferably, the second pump laser 144 is a 980 nanometer pump laser and has a power of approximately 180 mW, although those skilled in the art will recognize that the second pump laser 144 may be other than 980 nanometers, such as 1480 nanometers, and have a power of other than 180 mW. Also preferably, a reflector 149 is optically disposed in the third signal line 124. The reflector 149 may be a fiber grating or other reflector designed to reflect predetermined wavelengths. While a single reflector 149 is shown, those skilled in the art will recognize that the reflector 149 may include a plurality of reflectors 149. Preferably, the reflector 149 is tuned to reflect light having a wavelength of approximately 1558 nm.

A downstream end of the second amplifying gain medium 140 is optically connected to a third amplifying gain medium 160 through a second optical isolator 150. Preferably, the third amplifying gain medium 160 is a rare earth doped medium, such as a fiber or a planar waveguide. Also preferably, the third amplifying gain medium 160 is approximately one hundred and twenty meters long. A third optical multiplexer 162 optically connects an amplifying power source, preferably a third pump laser 164, to the third amplifying gain medium 160 via a pump line 166. Preferably, the third pump laser 164 is a 980 nanometer pump laser and has a power of approximately 200 mW, although those skilled in the art will recognize that the third pump laser 164 may be other than 980 nanometers, such as 1480 nanometers, and have a power of other than 200 mW. Also preferably, a reflector 168 is optically disposed between the second amplifying gain medium 160 and the third optical multiplexer 162. The reflector 168 may be a fiber grating or other reflector designed to reflect predetermined wavelengths. While a single reflector 168 is shown, those skilled in the art will recognize that the reflector 168 may include a plurality of reflectors 168. Preferably, the reflector 168 is tuned to reflect light having a wavelength of approximately 1560 nm.

An auxiliary power source in the form of a fourth pump laser 174 is optically connected to a fourth optical multiplexer 172 optically downstream of the third amplifying gain medium 160 via a pump line 176. Preferably, fourth pump laser 174 is a 980 nanometer pump laser and has a power of approximately 200 mW, and is disposed to provide counter-pumping for the amplifying gain medium 160, although those skilled in the art will recognize that the fourth pump laser 174 may be other than 980 nanometers, such as 1480 nanometers, and have a power of other than 200 mW. Also preferably, a reflector 178 is optically disposed between the second amplifying gain medium 160 and the fourth optical multiplexer 172. The reflector 178 may be a fiber grating or other reflector designed to reflect predetermined wavelengths. While a single reflector 178 is shown, those skilled in the art will recognize that the reflector 178 may include a plurality of reflectors 178. Preferably, the reflector 178 is tuned to reflect light having a wavelength of approximately 1555 nm.

Although the Figure shows the third amplifying gain medium 160 to be disposed optically downstream from the second amplifying gain medium 140, those skilled in the art will recognize that the second amplifying gain medium 140 may be disposed optically downstream from the third amplifying gain medium 160, instead.

An optical combiner 180 is disposed optically downstream from the first amplifying gain medium 130 and the third amplifying gain medium 160 and combines the first signal line 122 and the second signal line 124 to form the amplifier output 192, disposed optically downstream of the optical combiner 180. Similar to the optical splitter 120, the optical combiner 180 may be an AWG, a WDM or an optical circulator with optical gratings. A third optical isolator 190 is optically disposed along the amplifier output 192. The third optical isolator 190 prevents optical noise from traveling backwards to the amplifier 100 from a receiver (not shown) disposed optically downstream of the amplifier 100.

Operation of the amplifier 100 is as follows. The broadband signal light λ_{S}, having a spectrum of approximately between approximately 1565 and 1620 nm, is provided to the input 102 from the transmission source (not shown). The signal light λ_{S} travels through the optical isolator 110 and to the optical splitter 120. The optical splitter 120 splits the signal light λ_{S} into the L band signal light λ_{L}, having wavelengths of approximately between 1565 and 1605 nanometers, and the ultra-L band signal light λ_{LL}, having wavelengths of approximately between 1605 and 1620 nanometers. The L band signal light λ_{L} is transmitted along the signal line 122 to the first optical multiplexer 132, where first pump light λ_{P1}, generated by the first pump laser 134 and transmitted along the pump line 136, joins the L band signal light λ_{L}.

The combined L band signal light λ_{L} and first pump light pl are transmitted along the first amplifying gain medium 130 where the L band signal light λ_{L} is amplified, as is well known to those skilled in the art. Backward ASE, generated during amplification of the L band signal light λ_{L}, is transmitted from the first amplifying gain medium 130 along the signal line 122 optically toward the optical splitter 120. ASE having a wavelength of approximately between approximately 1535 to 1560 nanometers is reflected by the reflector 138 back into the first amplifying gain medium 130. The ASE acts as a seed to supplement the pump power of the first pump laser 134, increasing the amplification of the L band signal light λ_{L}.

The ultra-L band signal light λ_{LL} is transmitted along the signal line 124 to the second optical multiplexer 142, where second pump light λ_{P2}, generated by the second pump laser 144 and transmitted along the pump line 146, joins the ultra-L band signal light λ_{LL}.

The combined ultra-L band signal light λ_{LL} and second pump light λ_{P2} are transmitted along the second amplifying gain medium 140 where the ultra-L band signal light λ_{LL} is amplified. Backward ASE, generated during amplification of the ultra-L band signal light λ_{LL}, is transmitted from the second amplifying gain medium 140 along the signal line 124 optically toward the optical splitter 120. ASE having a wavelength of approximately 1558 nanometers is reflected by the reflector 146 back into the second amplifying gain medium 140. The ASE acts as a seed to supplement the pump power of the second pump laser 144, increasing the amplification of the ultra-L band signal light λ_{LL}.

The ultra-L band signal light λ_{LL} is further transmitted along the signal line 124, through the second optical isolator 150, to the third optical multiplexer 162, where third pump light λ_{P3}, generated by the third pump laser 164 and transmitted along the pump line 166, joins the ultra-L band signal light λ_{LL}.

The combined ultra-L band signal light λ_{LL} and third pump light λ_{P3} are transmitted along the third amplifying gain medium 160 where the ultra-L band signal light λ_{LL} is further amplified. Backward ASE, generated during amplification of the ultra-L band signal light λ_{LL}, is transmitted from the third amplifying gain medium 160 along the signal line 124 optically toward the second amplifying gain medium 140. ASE having a wavelength of approximately 1560 nanometers is reflected by the reflector 168 back into the third amplifying gain medium 160. The ASE acts as a seed to supplement the pump power of the third pump laser 164, increasing the amplification of the ultra-L band signal light λ_{LL}.

Generally simultaneously, the fourth pump laser 174 provides a fourth pump light λ_{P4} to counter-pump the third amplifying gain medium 160. The fourth pump light λ_{P4} is counter-pumped through the third amplifying gain medium 160 toward the optical splitter 120, where the ultra-L band signal light λ_{LL} is further amplified. Forward ASE, generated during amplification of the ultra-L band signal light λ_{LL} by the counter-pumping, is transmitted from the third amplifying gain medium 160 along the signal line 124 optically toward the optical combiner 180. ASE having a wavelength of approximately 1555 nanometers is reflected by the reflector 178 back into the third amplifying gain medium 160. The ASE acts as a seed to supplement the pump power of the fourth pump laser 174, increasing the amplification of the ultra-L band signal light λ_{LL}. The remaining ASE is absorbed by the second optical isolator 150.

The ultra-L band signal light λ_{LL}, now amplified, combines with the L band signal light λ_{L}, also now amplified, at the combiner 180 to reform the signal light λ_{S}, now amplified, which is transmitted along the amplifier output 192, the third optical isolator 190, and out of the amplifier 100. Those skilled in the art will recognize that a gain flattening filter, not shown, may be installed in the first and second signal lines 122, 124, optically downstream from the first and third amplifying gain media 130, 140, to flatten the gain of the ultra-L band signal light λ_{LL} and the L band signal light λ_{L}.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An optical amplifier comprising:
an input;
an optical splitter optically connected to the input, the optical splitter being adapted to split the input into at least a first band signal portion and a second band signal portion, the first band signal portion including:
a first reflector disposed optically downstream from the input;
a first amplifying gain medium disposed optically downstream from the first reflector;
a second reflector disposed optically downstream from the first amplifying gain medium;
a first amplifying power source optically connected to the first amplifying gain medium optically upstream from the first amplifying gain medium; and
a second amplifying power source optically connected to the first amplifying gain medium optically downstream from the first amplifying gain medium;
wherein the first reflector reflects a first light from the first amplifying medium back into the first amplifying medium and the second reflector reflects a second light from the first amplifying medium back into the first amplifying medium; and
an optical combiner optically connected to the at least first and second band signal portions to form an output.

2. The optical amplifier according to claim 1, wherein the optical amplifier is adapted to amplify a plurality of optical wavelengths in a band between 1610 and 1620 nanometers.

3. The optical amplifier according to claim 1, wherein the optical splitter comprises a wavelength division multiplexer.

4. The optical amplifier according to claim 1, wherein the optical splitter comprises an optical circulator.

5. The optical amplifier according to claim 1, wherein the optical splitter comprises an arrayed waveguide grating.

6. The optical amplifier according to claim 1, wherein each of the amplifying gain media comprises a rare earth doped medium.

7. The optical amplifier according to claim 6, wherein the rare earth doped medium comprises a fiber.

8. The optical amplifier according to claim 6, wherein the rare earth doped medium comprises a planar waveguide.

9. The optical amplifier according to claim 1, wherein the first band signal portion further comprises:
a second amplifying gain medium;
a third reflector optically disposed upstream of the second amplifying gain medium; and
a third amplifying power source optically connected to the second amplifying gain medium optically upstream from the second amplifying gain medium,
wherein the third reflector reflects a third light from the second amplifying gain medium back into the second amplifying gain medium.

10. The optical amplifier according to claim 9, wherein the third light has a wavelength of approximately 1558 nanometers.

11. The optical amplifier according to claim 9, wherein the second amplifying gain medium is disposed optically upstream from the first amplifying gain medium.

12. The optical amplifier according to claim 9, wherein the second amplifying gain medium is disposed optically downstream from the first amplifying gain medium.

13. The optical amplifier according to claim 1, wherein the first light has a wavelength of approximately 1560 nanometers.

14. The optical amplifier according to claim 1, wherein the second light has a wavelength of approximately 1555 nanometers.

15. The optical amplifier according to claim 1, wherein the optical amplifier is adapted to amplify light having wavelengths between approximately 1565 and 1620 nanometers.

16. The optical amplifier according to claim 1, wherein the first and second lights are C band light.

17. The optical amplifier according to claim 10, wherein the C band light is amplified spontaneous emission.

18. The optical amplifier according to claim 1, wherein the second band signal portion comprises:
a third reflector disposed optically downstream of the input;
a second amplifying gain medium disposed optically downstream from the third reflector; and
a third amplifying power source optically connected to the second amplifying gain medium optically upstream from the second amplifying gain medium;
wherein the third reflector reflects a third light from the second amplifying medium back into the second amplifying medium and the third reflector reflects a third light from the second amplifying medium back into the second amplifying medium.

19. The optical amplifier according to claim 18, wherein the third light has a wavelength of approximately 1558 nanometers.

20. The optical amplifier according to claim 18, wherein the third light is C band light.

21. The optical amplifier according to claim 20, wherein the C band light is amplified spontaneous emission.
